(19) United States
(12) Patent Application Publication
(10) Pub. No.: US 2011/0060557 A1
(43) Pub. Date: Mar. 10, 2011

(54) METHOD AND SYSTEM FOR TESTING A VEHICLE DESIGN

(75) Inventors: GIOVANNI DE PASCA, KOLN (DE); JOERG QUERENGAESSER, BERGISCH GLADBACH (DE); CLEMENS RICKERT, FRECHEN (DE)

(73) Assignee: FORD GLOBAL TECHNOLOGIES, LLC, DEARBORN, MI (US)

(21) Appl. No.: 12/878,023

(22) Filed: Sep. 8, 2010

(30) Foreign Application Priority Data
Sep. 9, 2009 (DE) 102009029318.3

(51) Int. Cl. G06G 7/70; G06F 17/50

(52) U.S. Cl. 703/1; 703/8

(57) ABSTRACT

A method and device for testing a vehicle design under predefined ambient conditions. A test driver is subjected to impressions of movement, which are generated as a function of the vehicle design and the ambient conditions, the vehicle design being present during the generation of the impressions of movement exclusively as a visual model, which is displayed to the test person.

### BACKGROUND

The present invention relates to methods and systems for testing vehicle design. In particular, the invention relates to a method and system, which assesses vehicle properties during the development process.

To assess developments in vehicle design it is often necessary to test a vehicle prototype under realistic driving conditions. Reliable assessment of these prototypes, however, is difficult under realistic conditions. Furthermore, as these tests require manufactured prototypes, they are executed in an advanced development stage, which can prove unfavorable in terms of economy. Moreover, under certain test circumstances, the repeated production of prototypes may be necessary, which may further add to vehicle costs. These tests may also be unfavorable for another reason—time consumption.

Some vehicle testing systems utilize driving simulators, which typically comprise complete vehicle operator control stations with naturalistic simulation of the operator control environment within a movably mounted cabin, to carry out vehicle-related tests or training programs. One such system, disclosed in German Patent DE3936877, simulates real driving situations in which vehicle control elements (such as steering wheels, activation pedals, etc.) are movably arranged with respect to the cabin of the vehicle. These elements can be moved in many directions of movement with respect to one another and with respect to the seat by means of assigned actuating elements controlled by a control unit.

Another patent, EP1435082B1, discloses a movement system for a driving simulator to generate motion in both a low- and high-frequency range and to simulate a large number of driving maneuvers in near-real conditions. In this system, a driver's cabin, which comprises a seat and operator control elements in the form of steering devices and activation pedals, is mounted on a manipulator having a turntable for controlled rotational movement of the cabin about its vertical axis and a six-axle movement unit for moving the assembly composed of the turntable and cabin in all six degrees of freedom of movement, as well as a horizontal displacement device for displacement along the two horizontal axes. The assembly composed of the carrier carriage, six-axle movement unit, turntable, and cabin forms a base unit, which is several tons in weight and is mounted in a low-friction fashion with respect to the floor surface by means of a pneumatic bearing.

Even though these systems can be utilized to test vehicle design in an early development stage, they provide room for further improvement in simulator design. For example, both these systems require real vehicle components for the tests. Moreover, even though these systems attempt to provide a near-real environment, they have not been able to do so successfully, leaving room for improvements. As a result, there exists a need for an improved vehicle design testing method and system, which reduces development costs and time consumption, while providing realistic driving conditions.

### SUMMARY

One embodiment of the present invention discloses a method for testing a vehicle design under predefined ambient conditions. The method includes the steps of displaying a three-dimensional visual model of the vehicle design, generating impressions of movement as a function of the vehicle design and the ambient conditions, and subjecting a test person to these impressions of movement.

Another embodiment of the present invention describes a system for testing a vehicle design. The system includes a driving simulator for simulating a driving movement of the vehicle design. The simulator includes operator control elements, which may be activated under predetermined ambient conditions in reaction to impressions of movement. Further, the system includes a vehicle simulation apparatus for presenting the vehicle design using digital data. The digital data is presented to a visualization device, which generates a visual model of the vehicle design from the digital data, and superimposes the visual model on a figurative representation of the ambient conditions to generate the impressions of movement.

Embodiments of the present invention provide numerous advantages. For example, some embodiments of the present invention reduce development costs by eliminating vehicle prototype requirements. The methods and systems introduced here utilize a virtual vehicle design (for example in the form of a complete vehicle model in a CAD format), which is digitally input into any desired environment, such as a city, suburb, or rural area on a sunny, rainy, windy or stormy day/night. During the testing process, a test person enters an immersive digital environment where he behaves as he would under corresponding real conditions. Moreover, as embodiments of the present invention utilize simulated environments and vehicle designs, vehicle testing can be completed in relatively lesser time and the vehicles can be tested in near-real conditions.

These and other advantages, features, and objects of the present application will become apparent upon review of the following detailed description of the preferred embodiments when taken in conjunction with the drawings and the appended claims.

### BRIEF DESCRIPTION OF THE DRAWINGS

The drawing figure described below sets out and illustrates a number of exemplary embodiments of the disclosure. Throughout the drawing, like reference numerals refer to identical or functionally similar elements. The drawing is illustrative in nature and is not drawn to scale.

FIG. 1 is block diagram of an exemplary vehicle design testing system according to embodiments of the present invention.

### DETAILED DESCRIPTION

### Overview

Embodiments of the present invention relate to methods and systems for testing design, expected driving behavior (handling properties) and expected driving comfort (ride properties) of a vehicle at an early development stage. Early testing can avoid development iterations, reducing costs and test time otherwise required at later points in the implementation process. The system is based, in particular, on the concept that during the testing of vehicle properties, the vehicle design under test is not in the form of a prototype but in the form of a virtual model (such as computer-based vehicle model in CAD format). This virtual vehicle model is input into any desired environment. During the testing, the driver enters, as it were, a virtual world and behaves here, as he would do under corresponding real conditions.

To provide this virtual world, the system generates a three-dimensional virtual vehicle model overlaid with a virtual environment, providing an immersive digital environment. This immersive environment can be provided, in particular, on the basis of a chroma-keying method. Moreover, to create as real a virtual image as possible, the system generates the images specifically for the test driver. The system tracks the driver's eye movement in real time and updates the virtual images in accordance with this movement, thereby providing a truly virtual experience. The system can generate any environmental condition, such as a busy city intersection, a long and winding suburban road, a highway, or hilly terrain. These conditions can be generated and captured by any suitable means, including digital video files or computer simulation. The ambient conditions may also be generated by mixing and superimposing, as desired, video files, computer simulations, and other suitable means for representing ambient conditions.

Along with the visualization apparatus, the system includes an actuated driving seat and control elements such as a steering wheel, pedals, and other dashboard components, within this immersive environment. A driver may operate these elements during various driving conditions to determine the viability of the vehicle design and to test its handling and riding properties. Activation of these control elements is synchronized with the digital environment. For example, if the driver suddenly accelerates, the virtual environment image will whiz by at a faster pace; alternatively, if the driver applies brakes, the virtual environment image will slow down. In this scenario, if the driver is not subjected to a physical impression of this movement (i.e., if he does not feel any physical reaction in accordance with the activation of the control elements), the driver may feel nauseous. To overcome this discomfort, the system synchronizes actuation of the driver's seat with the activation of the control elements and the change in the virtual environment. Therefore, any sudden acceleration by the driver can be visually experienced by a change in the scenery and can be physically sensed by movement of the driver's seat in accordance with the extent of acceleration.

In another embodiment, the operator control elements may be virtually represented in the vehicle model and detected based on movements of the test driver. In this case, only those operator control elements requiring intensive tested are implemented using hardware, leaving to simulation the remaining control elements, such as, pushbutton keys in the dashboard area or central console area. In this manner, it is possible to change over between different operator control concepts purely using software, which increases the degree of flexibility.

The movements of the test driver, in particular the movement of the driver's fingers, may be sensed using cameras or gloves equipped with sensors. These movements can be recorded electronically and evaluated later in ergonomic terms, such as handhold technique, activation travel, frequency of activation of certain operator control elements, etc. Analysis of these movements helps ascertain the ease with which a driver can control vehicle equipment while driving under various ambient conditions.

In addition, the systems and methods described here may test driving assistance systems, such as semi-automatic parking assistance systems, lane change assistance systems, lane departure warning apparatuses, apparatuses for sensing a blind spot, rear-end warning devices, adaptive cruise controllers, or automatic lighting systems.

Embodiments of the methods described here assess vehicle properties while providing realistic driving conditions even before prototype fabrication. In this context, the assessment of the driving behavior can take place with respect to a multiplicity of different aspects, for example ergonomic aspects or visual conditions.

### Exemplary System

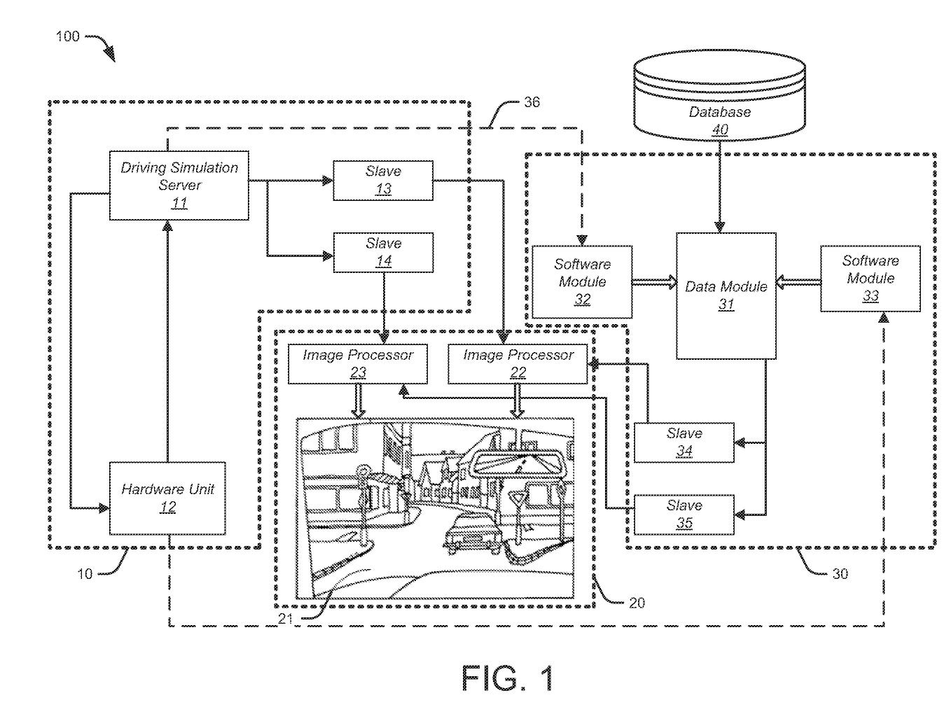

FIG. 1 is a block diagram illustrating an exemplary vehicle design testing system 100. Here, the system 100 is described using a passive virtualization system for a single screen solution, but it will be understood that embodiments of the present invention may also function in an active virtualization environment, or a multiple screen solution (e.g., Cave), without departing from the scope of the present invention. The system 100 includes a driving simulator 10, a visualization apparatus 20, and a vehicle representation apparatus 30.

The driving simulator 10 includes operator control elements such as an activatable driver's seat, a steering wheel, pedals, and adjustment controls for the seat, steering wheel, and pedals. These control elements may be virtual components or hardware components, based on specific system requirements. For example, the activatable driver's seat, steering wheel, and pedals may be hardware components, while adjustments controls, air-conditioning controls, audio controls, etc., may be virtual components. For illustrative purposes, these operator control elements are combined in FIG. 1 as hardware unit 12.

The test operator may activate the hardware unit 12 based on the virtual impressions of movements, which are displayed to the operator during the travel simulated by the driving simulator 10 via the visualization apparatus 20. Furthermore, the driving simulator 10 includes a simulation server 11, which performs two functions—supplying a movement signal to the hardware unit 12 (such as the driver's seat) based on the impressions of movement, and receiving an activation of control elements signal from the hardware unit 12. The simulation server 11 passes the data relating to the driving behavior to the visualization apparatus 20 via slave computing units 13 and 14. Here, the slave unit 13 generates visualization data for the right eye, and the slave unit 14 generates visualization data for the left eye. The driving simulator 10 is, according to the exemplary embodiment, synchronized with the vehicle representation apparatus 30, which is represented in FIG. 1 by means of the double arrowhead connector 36 between the simulation server 11 and a feedback software module 32 of the vehicle representation apparatus 30. The data module 31 of the vehicle representation apparatus 30 receives the data relating to the vehicle movement from the hardware unit 12 of the driving simulator 10 via a further software module 33.

The vehicle representation apparatus 30 includes one or more computing devices or modules for providing a visual representation of the vehicle under test. These modules may include a data module 31, which receives complete vehicle model data from a database, such as database 40. This data module 31 in turn supplies this data to slave computing devices 34 and 35. The vehicle representation apparatus 30 provides the visual representation of the vehicle separately for the right and left eye of the test person. To this end, the slave units 34 and 35 prepare vehicle images for the right and left eye respectively, and act as a path for transferring the vehicle data to the visualization apparatus 20. It will be understood, however, that the particular functions of the slave units 34 and 35 can be easily interchanged. In alternate embodiments, a single slave unit may prepare the left and right eye vehicle image data, an alteration that does not depart from the scope of the present invention.

The visualization apparatus 20 has image processors (generally referred to as “spider” processors) 22 and 23. The image processor 22 receives data for the right eye from the slave unit 34 for preparing images for the vehicle representation apparatus 30, and from the slave unit 13 for data from the driving simulator 10, which relates to the driving behavior. Correspondingly, the image processor 23 is provided with the data for the left eye from the slave unit 35 for the preparation of images for the vehicle representation apparatus 30, and from the slave unit 14 for the data from the driving simulator 10, which relates to the driving behavior.

According to one embodiment, the visualization apparatus 20 operates according to a chroma-keying method in which images or video data from the vehicle representation apparatus 30 and the driving simulator 10 are superimposed on one another. This may be accomplished in a number of different ways, this will be understood by those in the art. For example, the images may be superimposed by removing a color (or a narrow color range) from the color space in one image, or by increasing the transparency of one image, as a result of which the image behind it becomes visible when the two images are combined.

The visualization apparatus 20 displays the vehicle model, with the figurative representation of the ambient conditions superimposed on the model in a synchronized fashion. The vehicle model is presented to the driver during the generation of the impressions of movement, with the driver then behaving during the activation of the operator control elements in the driving simulator 10 as he would do under real conditions. As a result, testing the vehicle design is made possible under conditions that approach reality while considerably reducing the expenditure and time required for development, and in some embodiments allowing design-related visual conditions to be varied in a very flexible way.

The superimposed image is presented on a display 21 by means of the two image processors 22 and 23, which generate the visual model, in the corresponding environment, directly or indirectly on the display 21. Indirect generation occurs if the display 21 comprises one or more active display screens and these display screens are controlled by the image processors 22, 23. Direct generation occurs if the display 21 is a movie-type screen and the image processors 22, 23 contain one or more image projectors, which project the visual model onto the movie-type screen.

Embodiments of the present invention may be applied to test vehicle design of any vehicle type including limousines, SUVs, vans (small buses), sedans, hatchbacks, or station wagons.

The specification has set out a number of specific exemplary embodiments, but those skilled in the art will understand that variations in these embodiments will naturally occur in the course of embodying the subject matter of the disclosure in specific implementations and environments. It will further be understood that such variation and others as well, fall within the scope of the disclosure. Neither those possible variations nor the specific examples set above are set out to limit the scope of the disclosure. Rather, the scope of claimed invention is defined solely by the claims set out below.

What is claimed is:

1. A method for testing a vehicle design under predefined ambient conditions, the method comprising:
displaying the vehicle design as a virtual immersive visual model;
generating impressions of movement as a function of the vehicle design and the ambient conditions; and
subjecting a test person to the impressions of movement.

2. The method as claimed in claim 1, wherein displaying the vehicle design comprises displaying the visual model as a CAD representation of the vehicle design.

3. The method as claimed in claim 1, wherein displaying the vehicle design comprises superimposing a figurative representation of the ambient conditions on the visual model.

4. The method as claimed in claim 3, wherein displaying the vehicle design comprises synchronizing the visual model with the figurative representation of the ambient conditions.

5. The method as claimed in claim 3, wherein the superimposing step comprises superimposing based on a chroma-keying method.

6. The method as claimed in claim 1, wherein the ambient conditions are represented as at least one of a digital video file or a computer simulation.

7. The method as claimed in claim 1, wherein testing of the vehicle design further comprises testing at least one driving assistance system.

8. The method as claimed in claim 1, wherein the movements of the test driver, in particular the movements of the finger of a hand or of both hands of the test driver, are followed by means of cameras or by means of gloves equipped with a corresponding sensor system.

9. The method as claimed in claim 8, wherein activations of operator control elements which are only represented in a virtual fashion in the visual model are detected on the basis of the movements of the test driver.

10. A device for testing a vehicle design comprising:
a driving simulator including operator control elements which are activated under predetermined ambient conditions in reaction to impressions of movement simulating a driving movement of the vehicle design,
a vehicle simulation apparatus for representing the vehicle design as digital data, and
a visualization apparatus, which generates a visual model for the vehicle design from these digital data and superimposes said visual model on a figurative representation of the ambient conditions in order to generate the impressions of movement.
